(19) United States
(12) Patent Application Publication
(10) Pub. No.: US 2026/0318347 A1
(43) Pub. Date: Oct. 15, 2026

(54) Offset Sealing Clip

(71) Applicant: Illinois Tool Works Inc., Glenview, IL (US)

(72) Inventor: Kathryn G. Bailey, Farmington, MI (US)

(21) Appl. No.: 19/635,048

(22) Filed: Mar. 31, 2026

Related U.S. Application Data
(60) Provisional application No. 63/786,362, filed on Apr. 10, 2025.

(51) Int. Cl. F16B 37/04; F16B 17/00

(52) U.S. Cl. CPC F16B 37/043; F16B 17/008

(57) ABSTRACT

An offset clip includes a body portion having an offset plate and a pair of resilient legs configured to engage a component to retain the offset clip relative thereto. An offset barrel extends from the offset plate and defines a through hole configured to receive a fastener. The offset barrel is configured to establish a predetermined stand-off distance between components when the fastener is installed, thereby reducing direct contact between the components. In certain embodiments, a seal element is coupled to a distal end of the offset barrel and is configured to form a seal when exposed to elevated temperatures. The offset clip may provide controlled spacing, retention, load transfer, and isolation between components, including mitigation of galvanic corrosion between dissimilar materials.

### RELATED APPLICATIONS

The present application claims priority to United States Provisional Patent Application No. 63/786,362, filed Apr. 10, 2025, and entitled “Offset Sealing Clip,” which is hereby incorporated by reference in its entirety.

### BACKGROUND

Automotive components require fastening solutions that are straightforward to manufacture and assemble while delivering high reliability and operational efficiency. In vehicle body and chassis applications, clips are frequently used to secure dissimilar materials, such as aluminum panels to steel structures or coated components to bare substrates. When such materials are placed in direct contact in the presence of moisture, salts, or road contaminants, galvanic corrosion may occur, leading to premature degradation, reduced structural integrity, and increased warranty costs. Additionally, these interfaces are often exposed to environmental ingress, making it desirable for fastening solutions to provide a sealing function that limits or prevents the intrusion of water, debris, and other contaminants.

Accordingly, notwithstanding existing developments, there is a need for fastening solutions that not only secure components, but also provide electrical and/or physical isolation and, in some cases, sealing between adjacent parts to mitigate galvanic corrosion and environmental exposure.

### SUMMARY

The present disclosure relates generally to an offset clip assembly to use when forming a connection between two components, such as vehicular components, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a topside isometric assembly view of a fastening system with a fastener assembly having an offset clip assembly in accordance with an aspect of this disclosure.

FIG. 1b illustrates a first topside isometric assembled view of the fastening system.

FIG. 1c illustrates a second topside isometric assembled view of the fastening system.

FIG. 1d illustrates a cross-sectional side elevation view of the fastening system taken along cutline A-A (FIG. 1c).

FIG. 2a illustrates a topside isometric view of the offset clip for FIGS. 1a through 1d.

FIG. 2b illustrates an underside isometric view of the offset clip assembly.

FIG. 2c illustrates a top plan view of the offset clip assembly.

FIG. 2d illustrates a bottom plan view of the offset clip assembly.

FIG. 2e illustrates an elevation view of a first side of the offset clip assembly.

FIG. 2f illustrates an elevation view of a second side of the offset clip assembly.

FIG. 2g illustrates an elevation view of a third side of the offset clip assembly.

FIG. 2h illustrates an elevation view of a fourth side of the offset clip assembly.

FIG. 2i illustrates a cross-sectional side view of the offset clip assembly taken along cutline B-B (FIG. 2a).

FIG. 2j illustrates a topside isometric assembly view of the offset clip assembly.

FIG. 2k illustrates a side elevation assembly view of the offset clip assembly.

FIG. 3 illustrates an underside isometric view of an offset clip assembly in which the sealing assembly is omitted.

FIG. 4 illustrates a side assembly view of a fastening system with a fastener assembly having an offset clip assembly in accordance with another aspect of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain examples” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed herein is an offset clip configured to provide isolation and/or sealing at an interface between two components, such as vehicular components, while also facilitating secure fastening therebetween. The offset clip may be particularly advantageous in environments where controlled spacing, load distribution, and environmental sealing are desired, including but not limited to automotive, aerospace, and industrial applications. The disclosed offset clip is therefore configured to establish a predetermined stand-off distance between adjacent components while simultaneously enabling retention to one of the components and alignment of a fastener assembly. The offset clip may further incorporate features that facilitate sealing, vibration isolation, and mitigation of galvanic corrosion, particularly when used between dissimilar materials.

In one example, an offset clip assembly configured to provide spacing between a first component and a second component comprises: a clip body including an offset plate; a pair of legs extending from the clip body, the legs being resiliently deformable and configured to engage the first component to retain the offset clip assembly relative thereto; an offset barrel extending from the offset plate, the offset barrel defining a through hole configured to receive a fastener; and a seal element coupled at a distal end of the offset barrel; wherein the offset barrel defines a height configured to establish a predetermined stand-off distance between the first component and the second component when the fastener is installed, and wherein the seal element is configured to form a seal relative to at least one of the first component or the second component.

In some examples, the pair of legs are configured to be received within a pair of clip slots formed in the first component.

In some examples, the legs include one or more retention features configured to engage edges of the first component.

In some examples, the retention features comprise at least one of tabs, barbs, protrusions, or detents.

In some examples, the legs are generally parallel to one another.

In some examples, the legs extend generally perpendicular from the offset plate.

In some examples, the clip body includes one or more spring bends configured to enable elastic deformation of the legs during engagement with the first component.

In some examples, the offset barrel extends substantially perpendicular from the offset plate.

In some examples, the offset barrel comprises a cylindrical wall.

In some examples, the cylindrical wall is formed by drawing or extrusion of material from the offset plate.

In some examples, the offset barrel is positioned between the legs.

In some examples, the through hole is sized to slidingly receive a shank of the fastener extending between the first component and the second component.

In some examples, the clip body, the legs, and the offset barrel are integrally formed from a single piece of material.

In some examples, the offset barrel is coupled to the offset plate as a separate component.

In some examples, the offset clip further comprises an annular collar at the distal end of the offset barrel, the annular collar and the offset barrel defining a recess configured to receive the seal element.

In some examples, the seal element is retained by at least one of an interference fit, mechanical capture, or adhesive.

In some examples, the seal element is configured to soften, flow, or melt when exposed to elevated temperature.

In some examples, the seal element is configured to form a fluid-resistant seal during a paint oven process.

In some examples, the offset clip assembly is configured to reduce direct contact between the first component and the second component to mitigate galvanic corrosion.

In some examples, the offset clip assembly is configured such that, when a fastener is installed between the first component and the second component, a compressive load is transferred through the offset barrel to maintain the predetermined stand-off distance.

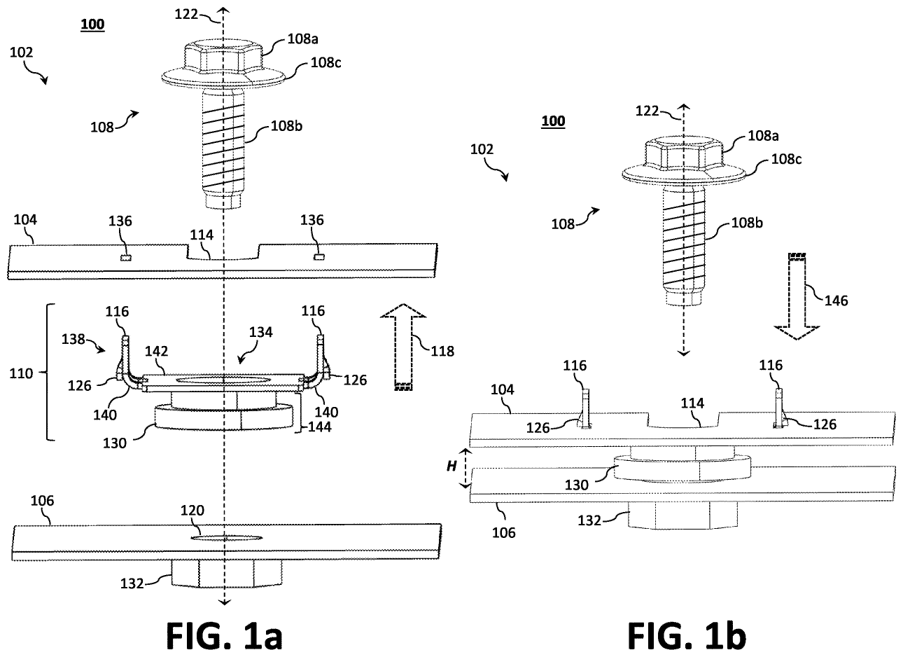

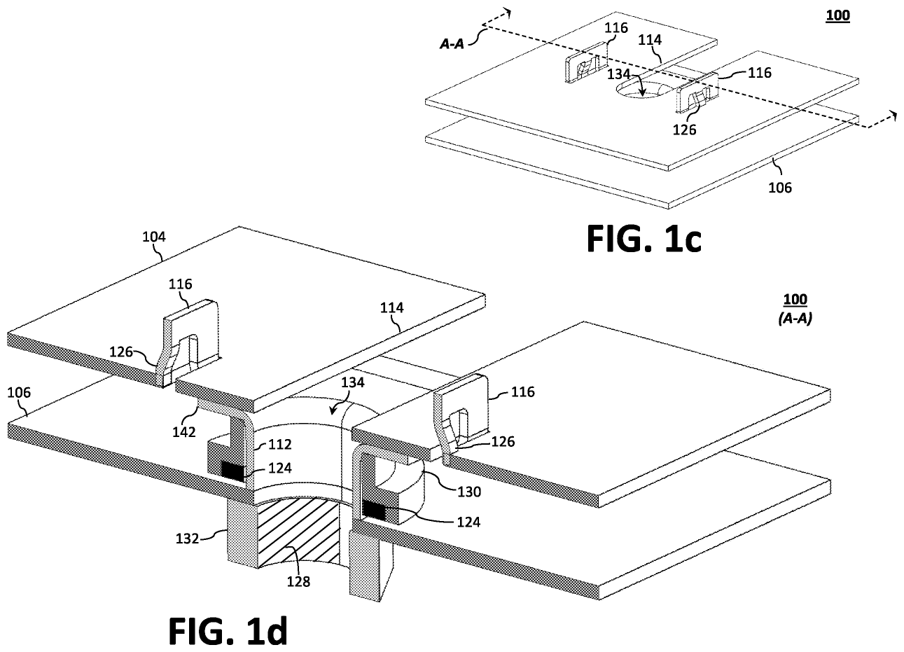

FIGS. 1a-1d illustrate various views of a fastening system 100 including a fastener assembly 102 having an offset clip assembly 110 in accordance with an aspect of the present disclosure. In particular, FIG. 1a illustrates a topside isometric assembly view of the fastening system 100; FIGS. 1b and 1c illustrate respective topside isometric assembled views of the fastening system 100; and FIG. 1d illustrates a cross-sectional side elevation view of the fastening system 100 taken along cutline A-A of FIG. 1c.

The fastening system 100 can include a fastener assembly 102 configured to couple a first component 104 to a second component 106. While particularly suitable for automotive applications, the fastening system 100 and offset clip assembly 110 may be used in other industries and environments where component isolation, sealing, and/or secure retention are desirable, including structural assemblies, appliances, enclosures, and equipment housings.

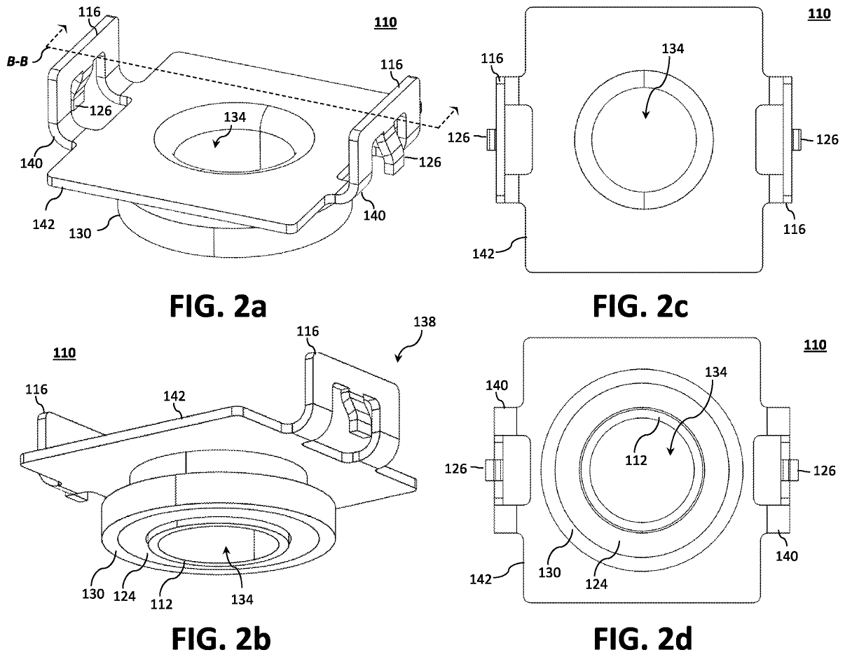

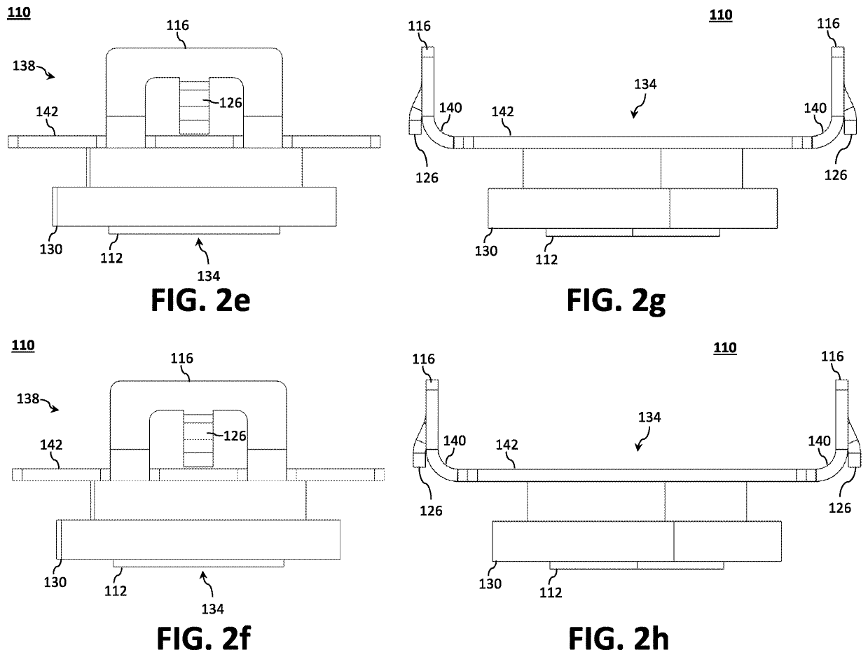

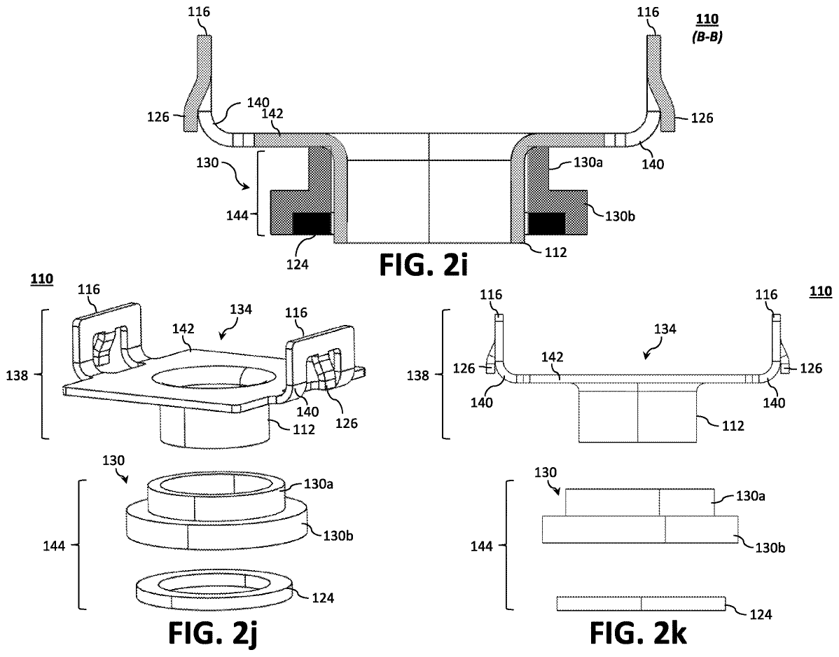

FIGS. 2a-2k illustrate various detailed views of the offset clip assembly 110 of FIGS. 1a-1d. More specifically, FIG. 2a illustrates a topside isometric view of the offset clip assembly 110, and FIG. 2b illustrates an underside isometric view thereof. FIGS. 2c and 2d illustrate top and bottom plan views, respectively. FIGS. 2e-2h illustrate elevation views of respective sides of the offset clip assembly 110. FIG. 2i illustrates a cross-sectional side view taken along cutline B-B of FIG. 2a. FIGS. 2j and 2k illustrate assembly views of the offset clip assembly 110, including a topside isometric assembly view and a side elevation assembly view, respectively.

The illustrated fastener assembly 102 includes a first fastener 108 (e.g., a male fastener, such as a bolt or screw), a second fastener 132 (e.g., a female fastener, such as a clinch nut, weld nut, or threaded insert), and an offset clip assembly 110. The second fastener 132 is configured to threadedly receive the first fastener 108 along the axis 122. In certain embodiments, the second fastener 132 may be rotationally fixed relative to the second component 106, such as by clinching, welding, or other attachment methods.

The first component 104 and the second component 106 may be fabricated from similar or dissimilar materials. For example, in automotive applications, the first component 104 may comprise a steel structural member, while the second component 106 may comprise an aluminum panel, coated substrate, composite structure, or polymeric trim component. When dissimilar metals are placed in contact in the presence of moisture or contaminants, galvanic corrosion may occur. The offset clip assembly 110 is configured to maintain controlled spacing between the first component 104 and the second component 106 when installed, thereby reducing or eliminating direct metal-to-metal contact and mitigating galvanic corrosion.

To facilitate installation of the fastener assembly 102, the first component 104 can include a first opening 114 and a pair of clip slots 136, and the second component 106 can include a second opening 120. In the illustrated embodiment, the first opening 114 is a large slot dimensioned to receive at least a portion of the first fastener 108 (e.g., axially or laterally), such as the shank 108b, while the second opening 120 is generally circular and dimensioned to receive at least a portion of the first fastener 108 (e.g., axially), such as the shank 108b. While illustrated as a slot, the first opening 114 could also be a generally circular hole like the illustrated second opening 120. The pair of clip slots 136 may be elongated or otherwise shaped to receive portions of the offset clip assembly 110.

Each of the first opening 114, the second opening 120, and the pair of clip slots 136 may be formed during manufacture of the respective components (e.g., stamping, punching, molding, or casting) or may be formed in a secondary operation (e.g., drilling, laser cutting, or machining). Optional chamfers, radiused edges, or lead-in features may be included to facilitate insertion, centering, and alignment of the offset clip assembly 110 and/or the first fastener 108.

When assembled, the second component 106 can be positioned relative to the first component 104 such that the second opening 120 is aligned with a seating area (e.g., deepest potion) the first opening 114 and the offset barrel 112 of the offset clip assembly 110 to allow the first fastener 108 to pass therethrough and engage the second fastener 132.

In this example, the offset clip assembly 110 is configured as a clip body 138 with the offset barrel 112 extending therefrom and a sealing assembly 144 coupled to a distal end thereof. The clip body 138 may be formed as a stamped metal clip and generally comprises an offset plate 142 and a pair of legs 116. The pair of legs 116 are generally parallel to one another and are resiliently coupled to the offset plate 142.

The offset barrel 112 is formed on, or otherwise coupled to, the offset plate 142 and is configured to extend generally perpendicularly from the offset plate 142. In an example, the offset barrel 112 is formed as a drawn barrel produced by deformation of the material of the offset plate 142. The pair of legs 116 are oriented such that the pair of legs 116 and the offset barrel 112 are oriented in opposite directions.

The distance (offset) between the first component 104 and the second component 106 is achieved and maintained by the offset barrel 112. The height of the offset barrel 112, which may also be referred to as a standoff distance, can be selected to establish a predetermined gap height (H) as illustrated in FIG. 1b. In other words, the height of the offset barrel 112 corresponds to the desired stand-off or isolation height when installed between components 104, 106.

To create the offset between the first component 104 and the second component 106, the pair of legs 116 of the offset clip assembly 110 are inserted into the pair of clip slots 136 formed in the first component 104 to securely clip the offset clip assembly 110 into place relative to the first component 104. During insertion, the legs 116 may elastically deflect to pass through the clip slots 136 and then return toward their original configuration to engage edges of the clip slots 136.

As noted, the offset clip assembly 110 can be used in instances such as preventing galvanic corrosion between a steel panel and an aluminum panel. After the offset clip assembly 110 is secured to the first component 104, the first component 104 (with the offset clip assembly 110 attached) is placed over the second component 106 such that the first fastener 108 can pass through the aligned openings 114, 120 to engage the second fastener 132.

The offset barrel 112 creates and maintains a firm offset between the first component 104 and the second component 106 when the first fastener 108 is torqued down to the second fastener 132 positioned on the opposite side of the second component 106. Once engaged, the offset barrel 112 acts as a compression limiter.

In some examples, the offset clip assembly 110 is configured to form a seal with or around the second opening 120. To provide the seal, a sealing assembly 144 may be press fit over a distal end of the offset barrel 112. In the illustrated example, the sealing assembly 144 comprises a seal element 124 (e.g., a plastic component) and an annular collar 130. As illustrated, the annular collar 130 generally comprises a first cylindrical portion 130a (a narrow cylindrical portion) and a second cylindrical portion 130b (a wider cylindrical portion). When assembled, the annular collar 130 and the offset barrel 112 form an annular recess configured to contain the seal element 124. The first cylindrical portion 130a is sized to form a friction fit with the offset barrel 112, while the second cylindrical portion 130b is coupled thereto and sized to form the annular recess. The annular collar 130 (e.g., via the second cylindrical portion 130b) also serves to provide an increase in contact area between the offset clip assembly 110 and the second component 106. That is, the annular collar 130 provides a further wider diameter than that of the second opening 120 of the second component 106.

The annular collar 130 may be provided as a separate component that is press fit, welded, bonded, or otherwise adhered to the offset barrel 112. In other examples, the annular collar 130 can be integrally formed with the offset barrel 112. The seal element 124 may be retained within the annular collar 130 (or the recess) by interference fit or mechanical capture.

When the offset clip assembly 110 is exposed to elevated temperatures, such as during passage through a paint oven, the seal element 124 may soften, flow, or melt. This thermal response can create a watertight or fluid-resistant seal around the second opening 120, thereby inhibiting ingress of moisture, dust, and other contaminants.

The combination of the offset clip assembly 110 and sealing assembly 144 thus provides a firm offset between the first component 104 and the second component 106, while also providing a sealing feature that can be installed prior to high-temperature processing and withstand such conditions.

The offset clip assembly 110 can include a clip body 138, which in certain embodiments may be formed from a single piece of material, such as sheet metal. The clip body 138 may include one or more planar portions, such as offset plate 142, connected by one or more integral spring bends 140. The spring bends 140 may be L-shaped (e.g., 90 degree turns) or otherwise contoured and can impart resilient characteristics to the offset clip assembly 110.

The spring bends 140 may enable the offset clip assembly 110 to elastically deform during insertion into the clip slots 136 and return toward a predetermined unstressed configuration to provide retention and/or clamping force.

In the illustrated embodiment, the offset plate 142 supports or defines the offset barrel 112. The pair of legs 116 extend generally perpendicular from the offset plate 142. One or more attachment features, such as tabs 126, may be provided on the legs 116 to engage edges of the clip slots 136 and provide retention.

These retention features may be configured to resist push-through of the offset clip assembly 110 relative to the first component 104 and may provide tactile and/or audible feedback when the offset clip assembly 110 is fully seated. Upon insertion, the legs 116 may elastically deflect and then engage the perimeter of the clip slots 136 or opening 114.

The offset plate 142 may comprise or define the offset barrel 112. The offset barrel 112 can include a cylindrical body. In certain embodiments, the cylindrical body may be formed by extrusion or drawing of material from the offset plate 142.

The second fastener 132 includes an internally threaded bore 128. The bore 128 may be configured to threadedly engage the externally threaded shank 108b of the first fastener 108. The second fastener 132 can be rotationally fixed relative to the second component 106 such that rotation of the first fastener 108 about axis 122 advances the fastener axially without causing substantial rotation of the second fastener 132 or the offset clip assembly 110.

The offset barrel 112 may comprise a short, hollow cylindrical wall defining a through hole 134. The through hole 134 can be aligned with and generally concentric to the internally threaded bore 128 of the second fastener 132 along axis 122. The through hole 134 can be sized to slidingly receive the shank 108b of the first fastener 108. The interior sidewall of the through hole 134 is preferable featureless (e.g., smooth) to mitigate interference with the first fastener 108 during assembly.

During tightening of the first fastener 108, compressive load can be transferred from the head 108a and flange 108c of the first fastener 108 to the second component 106 and then through the offset barrel 112 to the first component 104. Once the offset barrel 112 is engaged between the first component 104 and the second component 106, further tightening of the first fastener 108 may result primarily in load transfer through the offset barrel 112. This configuration mitigates direct contact between the first and second components 104, 106 and prevents over-compression.

The first fastener 108 can include a head 108a, a shank 108b, and a flange 108c. The head 108a may be hexagonal or otherwise configured to facilitate engagement by a tool. The shank 108b may include external threads configured to mate with the internally threaded bore 128. The flange 108c can increase the contact surface area between the head 108a and the second component 106, distributing clamping load and reducing localized stresses.

During installation, the offset clip assembly 110 can be attached to the first component 104 via insertion of the legs 116 into the clip slots 136 in the direction indicated by arrow 118. The legs 116 may deflect as necessary to pass through the clip slots 136 and then engage the perimeter to retain the offset clip assembly 110 in position.

The first component 104 can then be positioned over the second component 106 such that the offset barrel 112 aligns with the second opening 120. The first fastener 108 can be inserted through the second opening 120 as indicated by arrow 146, through the through hole 134 of the offset barrel 112, and into threaded engagement with the second fastener 132. Rotation of the first fastener 108 about axis 122 advances the fastener axially and draws the first and second components 104, 106 together, while the offset barrel 112 maintains a predetermined minimum distance between the components.

Additional sealing elements may be provided to mitigate ingress of dust, dirt, water, or other environmental contaminants. For example, a compressible annular seal may be positioned radially about the shank 108b and axially between the first component 104 and the underside of the head 108a.

The components of the offset clip assembly 110 (e.g., the clip body 138 and annular collar 130) may be fabricated from sheet metal using stamping, punching, coining, bending, and extrusion operations. In certain embodiments, the offset clip assembly 110 can be formed from a single sheet of metal that is progressively stamped and bent to create the clip body 138, the offset barrel 112, the legs 116, the tabs 126, and associated features. The offset barrel 112 may be integrally formed from the material of the clip body 138.

The first fastener 108 and the second fastener 132 may be fabricated from metal using cold forming, forging, or machining techniques. In alternative embodiments, certain components may be fabricated from polymeric materials using injection molding or additive manufacturing processes, including fused deposition modeling (FDM), stereolithography (SLA), selective laser sintering (SLS), material jetting, binder jetting, powder bed fusion, directed energy deposition, vat photopolymerization, or similar processes.

The first component 104 and the second component 106 may comprise automotive panels, trim components, structural members, pillars, dashboard components, seat frames, center consoles, fenders, sheet metal framework, or other substrates. These components may be fabricated from metals or metal alloys, synthetic or semi-synthetic polymers (including acrylonitrile butadiene styrene (ABS) and polyvinyl chloride (PVC)), composite materials (including fiberglass), or combinations thereof.

The offset clip assembly 110 can provide secure retention within a component opening, controlled compression through the offset barrel 112, sealing, and isolation between adjacent components to mitigate galvanic corrosion. By separating retention and compression-limiting functions and integrating an engineered compression limiter into an offset clip compatible with standard apertures, the offset clip assembly 110 can enhance installation reliability, protect component integrity, and promote consistent performance over repeated installation and service cycles.

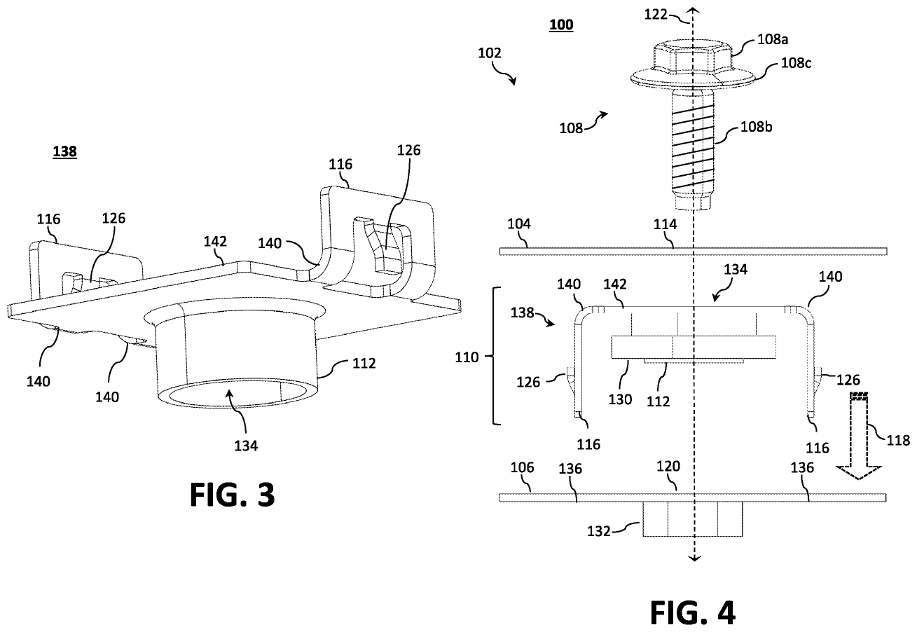

FIG. 3 illustrates an underside isometric view of an alternative embodiment of the offset clip assembly 110 in which the sealing assembly 144 is omitted, as described further herein. In some situations, sealing may not be desired or necessary. In such cases, as illustrated in FIG. 3, the seal element 124 and/or the annular collar 130 of the sealing assembly 144 can be omitted. In this embodiment, the offset clip assembly 110 operates in the same manner as described with respect to FIGS. 1a-1d and FIGS. 2a-2k, except that sealing functionality is not provided. The offset barrel 112 continues to define the stand-off distance, and the legs 116 continue to provide retention, thereby enabling the offset clip assembly 110 to function as a spacing and retention device without sealing features.

While the offset clip assembly 110 has been described as being coupled to the first component 104, it is contemplated that, in certain embodiments, the offset clip assembly 110 may instead be coupled to the second component 106 (e.g., adjacent the second fastener 132).

FIG. 4 illustrates a side assembly view of a fastening system 100 including a fastener assembly 102 having an offset clip assembly 110 in accordance with another aspect of the present disclosure. FIG. 4 illustrates a variation of the clip assembly 110 shown in FIGS. 1a-1d and 2a-2k, wherein the clip assembly 110 is configured to engage the second component 106 rather than the first component 104. The components and features of the offset clip assembly 110 of FIG. 4 are substantially similar to those described above with respect to FIGS. 1a-1d and 2a-2k. Accordingly, for the sake of brevity, such features are not described again in detail, and the following description focuses primarily on the distinguishing aspects of this variation.

In particular, the primary differences relate to the orientation and length of the legs 116. As illustrated, the pair of legs 116 remain generally parallel to one another and are resiliently coupled to the offset plate 142; however, in this embodiment, the pair of legs 116 are oriented such that the offset barrel 112 is positioned between the pair of legs 116.

Additionally, the length of each of the pair of legs 116 is increased relative to the previously described example to accommodate the height of the offset barrel 112. In this regard, the legs 116 extend beyond a distal end of the offset barrel 112 such that the tabs 126 are configured to engage an opposite panel (in this case, the second component 106), while the offset barrel 112 remains positioned between the first component 104 and the second component 106.

While specific embodiments have been described, it will be appreciated that variations in geometry, material, orientation, and configuration may be made without departing from the scope of the disclosure. The offset clip assembly 110 may be adapted for different component geometries, fastening arrangements, and environmental conditions, and may include additional or alternative features as required for a particular application.

Thus, while the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. An offset clip assembly configured to provide spacing between a first component and a second component, the offset clip assembly comprising:
a clip body including an offset plate;
a pair of legs extending from the clip body, the legs being resiliently deformable and configured to engage the first component to retain the offset clip assembly relative thereto;
an offset barrel extending from the offset plate, the offset barrel defining a through hole configured to receive a fastener; and
a seal element coupled at a distal end of the offset barrel;
wherein the offset barrel defines a height configured to establish a predetermined stand-off distance between the first component and the second component when the fastener is installed, and
wherein the seal element is configured to form a seal relative to at least one of the first component or the second component.

2. The offset clip of claim 1, wherein the pair of legs are configured to be received within a pair of clip slots formed in the first component.

3. The offset clip of claim 1, wherein the legs include one or more retention features configured to engage edges of the first component.

4. The offset clip of claim 3, wherein the retention features comprise at least one of tabs, barbs, protrusions, or detents.

5. The offset clip of claim 1, wherein the legs are generally parallel to one another.

6. The offset clip of claim 1, wherein the legs extend generally perpendicular from the offset plate.

7. The offset clip of claim 1, wherein the clip body includes one or more spring bends configured to enable elastic deformation of the legs during engagement with the first component.

8. The offset clip of claim 1, wherein the offset barrel extends substantially perpendicular from the offset plate.

9. The offset clip of claim 1, wherein the offset barrel comprises a cylindrical wall.

10. The offset clip of claim 9, wherein the cylindrical wall is formed by drawing or extrusion of material from the offset plate.

11. The offset clip of claim 1, wherein the offset barrel is positioned between the legs.

12. The offset clip of claim 1, wherein the through hole is sized to slidingly receive a shank of the fastener extending between the first component and the second component.

13. The offset clip of claim 1, wherein the clip body, the legs, and the offset barrel are integrally formed from a single piece of material.

14. The offset clip of claim 1, wherein the offset barrel is coupled to the offset plate as a separate component.

15. The offset clip of claim 1, further comprising an annular collar at the distal end of the offset barrel, the annular collar and the offset barrel defining a recess configured to contain the seal element.

16. The offset clip of claim 1, wherein the seal element is retained by at least one of an interference fit, mechanical capture, or adhesive.

17. The offset clip of claim 1, wherein the seal element is configured to soften, flow, or melt when exposed to elevated temperature.

18. The offset clip of claim 17, wherein the seal element is configured to form a fluid-resistant seal during a paint oven process.

19. The offset clip of claim 1, wherein the offset clip assembly is configured to reduce direct contact between the first component and the second component to mitigate galvanic corrosion.

20. The offset clip of claim 1, wherein the offset clip assembly is configured such that, when a fastener is installed between the first component and the second component, a compressive load is transferred through the offset barrel to maintain the predetermined stand-off distance.
